(19) United States
(12) Patent Application Publication
(10) Pub. No.: US 2025/0008171 A1
(43) Pub. Date: Jan. 2, 2025

(54) Grouping Of Video Streaming Messages

(71) Applicant: MediaTek Inc., Hsinchu City (TW)

(72) Inventors: Lulin Chen, San Jose, CA (US); Olena Chubach, San Jose, CA (US); Yu-Wen Huang, Hsinchu City (TW)

(21) Appl. No.: 18/757,366

(22) Filed: Jun. 27, 2024

Related U.S. Application Data
(60) Provisional application No. 63/510,642, filed on Jun. 28, 2023.
(60) Provisional application No. 63/518,961, filed on Aug. 11, 2023.
(60) Provisional application No. 63/520,370, filed on Aug. 18, 2023.

(51) Int. Cl. H04N 21/236; H04N 19/172; H04N 21/2343

(52) U.S. Cl. CPC H04N 21/23605; H04N 19/172; H04N 21/2343

(57) ABSTRACT

A video streaming server transmitting coded video for a current picture in a first set of network packets. The server generates a set of configuration data for the current picture. The server transmits the set of configuration data in a second set of network packets. The server transmits a particular network packet comprising a group identifier identifying a group that is applicable to the current picture, the identified group comprising the second set of network packets. A video streaming client receives the first set of network packets and reconstructs the current picture. The client receives the second set of network packets and the particular network packet. The client uses the group identifier in the particular network packet to identify the second set of network packets as being in the group that is applicable to the current picture. The client outputs the reconstructed current picture by applying the set configuration data.

### CROSS REFERENCE TO RELATED PATENT APPLICATION(S)

The present disclosure is part of a non-provisional application that claims the priority benefit of U.S. Provisional Patent Application No. 63/510,642 filed on 28 Jun. 2023, No. 63/518,961 filed on 11 Aug. 2023, and No. 63/520,370 filed on 18 Aug. 2023, respectively. Contents of above-listed applications are herein incorporated by reference.

### TECHNICAL FIELD

The present disclosure relates generally to video streaming. In particular, the present disclosure relates to methods of grouping Neural Network Post Filter (NNPF) and Supplemental Enhancement Information (SEI) messages.

### BACKGROUND

Unless otherwise indicated herein, approaches described in this section are not prior art to the claims listed below and are not admitted as prior art by inclusion in this section.

Video streaming is a continuous transmission of video files from a server to a client. Video streaming enables users to view videos online without having to download them. In video streams, content is sent in a compressed form over the internet and is displayed by the viewer in real time. The media is sent in a continuous stream of data and is played as it arrives. A video player is a program or device that uncompresses and provides video data to the display and audio data to speakers. Video streams begin with a prerecorded media file hosted on a remote server. Once the server receives a client request, the data in the video file is compressed and sent to the requesting device in pieces. Audio and video files are broken into data packets, where each packet contains a small piece of data. A transmission protocol such as Transmission Control Protocol (TCP) or User Datagram Protocol (UDP) is used to exchange data over a network. Once the requesting client receives the data packets, a video player on the user end will decompress the data and interpret video and audio. The video files are automatically deleted once played.

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

The coded video data is organized into Network Abstraction Layer (NAL) units, each of which is effectively a packet that contains an integer number of bytes. NAL units are classified into Video Coding Layer (VCL) and non-VCL NAL units. The VCL NAL units contain the data that represents the values of the samples in the video pictures, and the non-VCL NAL units contain any associated additional information such as parameter sets (e.g., important header data that can apply to a large number of VCL NAL units) and supplemental enhancement information (SEI) (e.g., timing information and other supplemental data that may enhance usability of the decoded video signal but are not necessary for decoding the values of the samples in the video pictures).

Supplemental enhancement information (SEI) is additional data that can be inserted into a bitstream of video content during encoding and transmission. SEI messages are metadata that are inserted into the bitstream as NAL units during encoding and transmission. SEI messages can be used for a variety of purposes, including decoding, display, and other applications. They can convey technical information related to the bitstream, such as camera or encoder parameters, time code, closed captions, lyrics, or copyright information.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a video streaming method. A video streaming server transmitting coded video for a current picture in a first set of network packets (e.g., VCL NAL units). The server generates a set of configuration data for the current picture. The server transmits the set of configuration data in a second set of network packets (e.g., non-VCL NAL units or SEI messages). The server transmits a particular network packet comprising a group identifier identifying a group that is applicable to the current picture, the identified group comprising the second set of network packets. A video streaming client receives the first set of network packets and reconstructs the current picture. The client receives the second set of network packets and the particular network packet. The client uses the group identifier in the particular network packet to identify the second set of network packets as being in the group that is applicable to the current picture. The client outputs the reconstructed current picture by applying the set configuration data.

The particular network data packet may assign processing order to the network data packets in the second set of network data packets. The particular network data packet may be a SEI processing order group characteristic (SPOGC) SEI message that associates persistence, purpose, grouping type, or other processing characteristics with the group identifier. The particular network data packet may be a SPOG activation (SPOGA) SEI message that activates or de-activates a processing function that uses the configuration data in the second set of network data packets. The activated/deactivated function may be a neural network post filter to be applied to the current picture and the generated configuration data is for configuring the neural network post filter. The group may be one of a plurality of groups that are associated with the current picture, the plurality of groups comprising multiple sets of network data packets for supporting respective multiple processing functions, which may be multiple neural network post filters to be applied to the current picture.

In some embodiments, the group identifier is a first group identifier for a first group comprising one or more network data packets and at least a second (nested) group associated with a second group identifier, with the second group including one or more network data packets.

### BRIEF DESCRIPTION OF THE DRAWINGS

The accompanying drawings are included to provide a further understanding of the present disclosure and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates a video streaming system that supports neural network post filters (NNPFs) by NNPF SEI messages.

FIGS. 2A-C illustrate the operations of a group of neural network post filters (NNPFs).

FIG. 3 conceptually illustrates SEI messages for setting the characteristics of SEI processing order groups (SPOGs).

FIG. 4 illustrates SEI messages that activates or deactivate one or more target SPOGs.

FIG. 5 conceptually illustrates a SEI message for setting the characteristics a SPOG that includes both SPOGs and SEI messages.

FIG. 6 conceptually illustrates a SEI message that activates or deactivates a combination that includes both SPOGs and SEI messages.

FIG. 7 illustrates an example video encoder that may be part of a video streaming server.

FIG. 8 illustrates a video streaming server device that implements grouping of SEI messages.

FIG. 9 conceptually illustrates a process for using grouping of SEI messages by a video streaming server.

FIG. 10 illustrates an example video decoder that may be part of a video streaming client.

FIG. 11 illustrates a video streaming client device that implements grouping of SEI messages.

FIG. 12 conceptually illustrates a process for using grouping of SEI messages by a video streaming client.

FIG. 13 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

Neural Network Post Filter (NNPF) SEI messages enable the use of neural networks for post-processing video streaming such as super-resolution, frame rate upsampling, chroma format conversion, and colorization. The NNPF characteristics (NNPFC) SEI message signals neural-network parameters/weights and additional information needed for a receiver to determine if it can implement the indicated neural network. Several neural networks can be signaled using multiple NNPFC SEI messages to support different receiver capabilities and different post-processing operations. Specific neural networks may be invoked from available neural networks using an NNPF activation (NNPFA) SEI message.

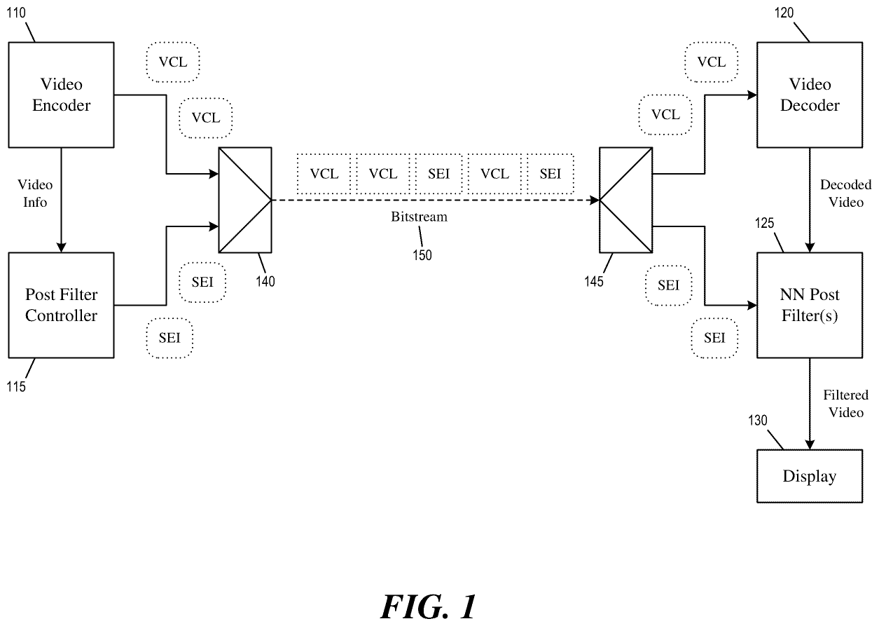

FIG. 1 conceptually illustrates a video streaming system 100 that supports neural network post filters (NNPFs) by NNPF SEI messages. In the video streaming system 100, a video encoder 110 generates encoded video content. The encoded video content is delivered as video content NAL units to a video decoder 120 to be reconstructed. The reconstructed video is post-processed by a neural network post filter 125 before being displayed at a display device 130.

The operations of the neural network post filter 125 are configured by post filter control data in SEI messages (specifically NNPF SEI messages), which are received along with the video content NAL units. (In the figure, the video content NAL units are labeled as “VCL” and SEI message NAL units are labeled as “SEI”, which are non-VCL NAL units.) The neural network control data in the SEI messages are generated by a post filter controller 115 based on information provided by the video encoder 110 regarding the video content.

An encoder side streaming multiplexer device 140 splices video content NAL units from the encoder 110 and the SEI messages from the post filter controller 115 as a bitstream 150. A decoder side streaming demultiplexer device 145 receives the bitstream 150 to provide the video content NAL to the video decoder 120 and SEI messages (at least those related to the neural network post filtering) to the neural network post filter 125.

In some embodiments, some or all of the devices in the encoder side (the encoder 110, the post filter controller 115, the multiplexer 140, etc.) are implemented by one computing device or even one integrated circuit. In some embodiments, some or all of the devices in the decoder side (the demultiplexer 145, the decoder 120, the neural network post filter 125, the display 130, etc.) are implemented by one computing device or even one integrated circuit.

### I. Specifying Multiple Neural Network Post Filters

In some embodiments, the neural network post filter 125 at the decoder side in FIG. 1 may include multiple NNPFs. These NNPFs may be organized into NNPF groups (also termed NNPF list). For an NNPF group, SEI messages may be used to specify some properties or operations, including group relationships and corresponding processing steps. In some embodiments, the operations and/or properties of a NNPF group are specified by a NNPF group characteristic SEI message, which provides group id, type, and purpose of the NNPF group. In some embodiments, the operations and/or properties of a NNPF group are specified by a NNPF group activation SEI message, which provides target NNPF group id.

In some embodiments, the SEI messages in a bitstream support multiple activated NNPFs (with the same or different purposes) for a picture encoded in the bitstream, in a cascading or alternative manner. In some embodiments, the SEI messages provide instructions for multiple activated NNPFs for a picture while the receiver may process the bitstream multiple times to generate multiple different results.

In some embodiments, the properties or operations of an NNPF group are addressed before the NNPF group can be used correctly for an intended purpose. In some embodiments, the properties or operations of an NNPF group is specified for a specific processing order with other SEI messages by the SEI processing order (SPO) SEI messages in the bitstream.

a. NNPF Group SEI Message

In some embodiments, NNPF group SEI messages are incorporated into to a SEI payload according to the following Tables 1-3:

TABLE 1

Descriptor

```
sei_payload( payloadType, payloadSize ) {
    SeiExtensionBitsPresentFlag = 0
    if( nal_unit_type = = PREFIX_SEI_NUT )
      if( payloadType = = 0 )
        buffering_period( payloadSize )
      else if( payloadType = = 1 )
        pic_timing( payloadSize )
      else if( payloadType = = 3 )
        filler_payload( payloadSize )
      else if( payloadType = = 4 )
        user_data_registered_itu_t_t35( payloadSize )
      else if( payloadType = = 5 )
        user_data_unregistered( payloadSize )
    ...
      else if( payloadType = = 19 )
        film_grain_characteristics( payloadSize )
      else if( payloadType = = 210 )
        nn_post_filter_characteristics( payloadSize )
      else if( payloadType = = 211 )
        nn_post_filter_activation( payloadSize )
      else if( payloadType = = 212 )
        phase_indication( payloadSize )
      else if( payloadType = = 213 )
        sei_processing_order( payloadSize )
      else if( payloadType = = 214 )
        nn_post_filter_group( payloadSize )
      else if( payloadType = = 215 )
        nn_post_filter_group_activation( payloadSize )
      else
        reserved_message( payloadSize )
  ...
  }
}
```

where nn_post_filter_group( ) is defined according to the following syntax:

TABLE 2

| | Descriptor |
|---|---|
| nn_post_filter_group( payloadSize ) { | |
| nnpfg_purpose | u(16) |
| nnpfg_id | ue(v) |
| nnpfg_operation | u(1) |
| num_nnpf_nnpfg_minus2 | ue(v) |
| for( i = 0; i <= num_nnpf_nnpfg_minus2 + 1; i++ ) | |
| nnpf_nnpfg_id[ i ] | ue(v) |
| } | |
| nnpfg_complexity_info_present_flag | u(1) |
| if( nnpfg_complexity_info_present_flag ) { | |
| ... | |
| } | |
| nnpfg_region_info_present_flag | u(1) |
| if( nnpfg_region_info_present_flag ) { | |
| ... | |
| } | |
| } | |

A neural-network post-filter group (NNPFG) SEI message specifies a neural network post-filter (NNPF) group comprising two or more combined NNPFs and/or NNPFGs applied in terms of the group operation. The use of NNPFG for specific pictures is indicated with neural-network post-filter group activation (NNPFGA) SEI messages. An NNPFG can be included in other NNPFGs, i.e., in a nested manner.

nnpfg_purpose indicates the purpose of the NNPF group and has the semantics of nnpfc_purpose.

nnpfg_id contains an identifying number that may be used to identify an NNPFG. The value of nnpfg_id shall be in the same range as that of the value of nnpfc_id. The value of nnpfg_id shall be unique and different from all values of nnpf_id and other values of nnpfg_id in the bitstream.

nnpfg_operation indicates the group relation and processing steps for an NNPFG. The value of nnpfg_operation shall be in the range of 0 to 7, inclusive, in bitstreams conforming to this edition of this document. Values of 4 to 7, inclusive, for nnpfg_operation are reserved for future use by ITU-T|ISO/IEC and shall not be present in bitstreams conforming to this edition of this document. Decoders conforming to this edition of this document shall ignore NNPFG SEI messages with nnpfg_operation in the range of 4 to 7, inclusive. The table below provides descriptions of nnpfg_operation:

TABLE 3

| Value | Description |
|---|---|
| 0 | Optional - Applying the NNPF and/or NNPFG is optional |
| 1 | Cascade - The NNPFs and/or NNPFGs in an NNPF group are |
| | applied in a way that the input pictures to the (i + 1)-th NNPF |
| | or NNPFG in an NNPF group are derived from the output of |
| | the i-th NNPF or NNPFG in the NNPF group. |
| 2 | Alternate - The NNPF or NNPFG in an NNPF group is applied |
| | alternatively (only one is chosen) to the associated picture |
| 3 | Coherence - The NNPFs and/or NNPFGs in an NNPF group are |
| | applied in parallel (in contrast to the cascade) to the |
| | associated picture |
| 4-7 | Reserved |

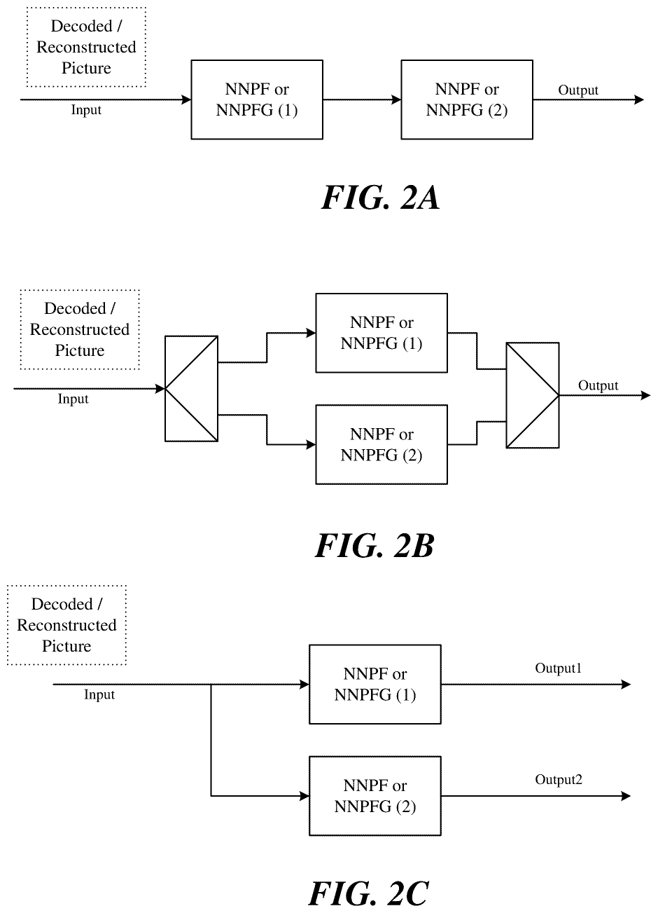

FIGS. 2A-C illustrate the operations of a group of neural network post filters (NNPFs) in three different cases: Cascade, Alternate, and Coherence. The value of nnpfg_operation is used to indicate one of the three cases according to Table 3. FIG. 2A illustrates a group of NNPFs or NNPFGs in cascade configuration (nnpfg_operation=1). FIG. 2B illustrates a group of NNPFs or NNPFGs in alternate configuration (nnpfg_operation=2). FIG. 2C illustrates a group of NNPFs or NNPFGs in coherence configuration (nnpfg_operation=3). Some constraints may further impose on input to an NNPF or NNPFG, for example, for a cascade case, a coherence NNPFG (with two outputs) may be followed by an NNPF (with one input).

num_nnpf_nnpfg_minus2 plus 2 indicates the number of NNPFs and/or NNPFGs in the NNPF group that this SEI message defines.

nnpf_nnpfg_id[i] indicates that the i-th NNPF or NNPFG in the NNPF group has nnpfc_id or nnpfg_id equal to nnpf_nnpfg_id[i]. Each NNPF or NNPFG with nnpfc_id or nnpfg_id equal to nnpf_nnpfg_id[i] is defined by one or more NNPFC messages or one NNPFG SEI message.

nnpfg_complexity_info_present_flag equal to 1 specifies that one or more syntax elements that indicate the complexity of the NNPFG associated with the nnpfg_id are present. nnpfg_complexity_info_present_flag equal to 0 specifies that no syntax elements that indicates the complexity of the NNPFG associated with the nnpfg_id are present.

nnpfg_region_info_present_flag equal to 1 specifies that one or more syntax elements that indicate the regions of the NNPFG associated with the nnpfg_id are present. nnpfg_region_info_present_flag equal to 0 specifies that no syntax elements that indicates the regions of the NNPFG associated with the nnpfg_id are present.

b. NNPF Group Activation SEI Message

A neural-network post-filter group activation (NNPFGA) SEI message activates or de-activates the possible use of the target neural-network post-processing filter group (NNPFG), identified by nnpfga_target_id, for post-processing filtering of a set of pictures. For a particular picture for which the NNPFG is activated, the target NNPFG is the NNPFG specified by the NNPFG SEI message with nnpfg_id equal to nnpfga_target_id, that precedes the first VCL NAL unit of the current picture in decoding order and the NNPFs or NNPFGs of the target NNPFG are defined by the NNPFC SEI messages or the NNPFG SEI messages that have nnpfc_id or nnpfg_id equal to any nnpf_nnpfg_id[i] value of the target NNPFG and are present in the current picture unit or precede the current picture in decoding order. The syntax of NNPFGA SEI message is provided in Table 4 below:

TABLE 4

| | Descriptor |
|---|---|
| nn_post_filter_group_activation( payloadSize ) { | |
| nnpfga_target_id | ue(v) |
| nnpfga_cancel_flag | u(1) |
| if( !nnpfga_cancel_flag ) { | |
| nnpfga_persistence_flag | u(1) |
| nnpfga_region_info_present_flag | u(1) |
| if( nnpfg_region_info_present_flag ) { | |
| ... | |
| } | |
| } | |
| } | |

nnpfga_target_id indicates the target NNPFG, which is specified by an NNPFG SEI message that pertain to the current picture and have nnpfg_id equal to nnpfga_target_id. The value of nnpfga_target_id shall be in the same range as that of the value of nnpfg_id.

nnpfga_cancel_flag equal to 1 indicates that the persistence of the target NNPFG established by any previous NNPFGA SEI message with the same nnpfga_target_id as the current SEI message is cancelled, i.e., the target NNPFG is no longer used unless it is activated by another NNPFGA SEI message with the same nnpfga_target_id as the current SEI message and nnpfga_cancel_flag equal to 0. nnpfga_cancel_flag equal to 0 indicates that the nnpfga_persistence_flag follows.

nnpfga_persistence_flag specifies the persistence of the target NNPFG for the current layer.

nnpfga_region_info_present_flag equal to 1 specifies that one or more syntax elements that indicate the regions of the NNPFG associated with the nnpfg_id are present. nnpfg_region_info_present_flag equal to 0 specifies that no syntax elements that indicates the complexity of the NNPFG associated with the nnpfg_id are present.

nnpfga_region_info_present_flag and nnpfga_region_info_present_flag may be used to specify the presence of static region information or dynamic region information. When all NNPFs of an NNPFG are the same, nnpfga_region_info_present_flag and nnpfga_region_info_present_flag may be used to specify the presence of static region information or dynamic region information for the NNPF rather than the NNPFG.

### II. Generic SEI Processing Order SEI Messages

SEI processing order (SPO) SEI messages are used for establishing processing order among SEI messages. SPO SEI message is useful not only for indicating stages of processing operations, but also for indicating the properties and intended uses of the video content after particular stages of processing. For some embodiments, the syntax for a SPO SEI message is shown in Table 5 below:

TABLE 5

| | Descriptor |
|---|---|
| sei_processing_order( payloadSize ) { | |
| po_num_sei_messages_minus2 | u(8) |
| for(i = 0; i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_6bits | u(6) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; j++ ) | |
| po_prefix_byte[ i ][ j ] | b(8) |
| } | |
| } | |
| po_sei_processing_order[ i ] | u(8) |
| } | |
| } | |

In some embodiments, the SEI processing order (SPO) SEI message is further extended to support various processing order types in addition to the cascade processing and to include the neural network post filter (NNPF) SEI messages in the SPO SEI message. The following sub-sections describes these improvements for some embodiments.

a. NNPF SPO SEI Messages

The NNPF SEI messages comprise the NNPF characteristics SEI message and the NNPF activation SEI message. The NNPF characteristic SEI messages precede the NNPF activation SEI message when present in the bitstream. The NNPF activation SEI message, when present, signals the NNPF processing in terms of the NNPF characteristic SEI message applied to the associated picture. And, like other non-NNPF SEI messages, the NNPF activation SEI message specifies the scope of persistence. Table 6 below is an example SPO SEI message that supports the NNPF SEI messages in the SPO SEI message for some embodiments.

TABLE 6

| | Descriptor |
|---|---|
| sei_processing_order( payloadSize ) { | |
| po_num_sei_messages_minus2 | u(8) |
| for( i = 0; i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_6bits | u(6) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; | |
| j++ ) | |
| po_prefix_byte[ i ][ j ] | b(8) |
| } | |
| } | |
| sei_activation_present_flag[ i ] | u(1) |
| if(sei_activation_present_flag[ i ] ) { | |
| reserved_alignment_7bit | u(7) |
| sei_message( ) //The corresponding activation SEI | |
| message, if applicable. | |
| } | |
| } | |
| } | |

po_num_sei_messages_minus2 plus 2 indicates the number of SEI messages that have a processing order indicated in the SEI processing order SEI message. The indicated SEI messages are processed in the sequential order as specified with the index i from 0 to po_num_sei_messages_minus2+1, inclusive, which means the indicated SEI messages are ordered with increasing values of the index i.

sei_activation_present_flag[i] equal to 1 indicates the activation SEI message following the i-th SEI message is present. sei_activation_present_flag[i] equal to 0 indicates the activation SEI message following the i-th SEI message is not present. The activation SEI message, when present, is applicable for the i-th SEI message as the activation for use.

Thus, in addition to indicating an SEI message, the corresponding activation SEI message is also indicated (sei_activation_present_flag) if applicable. This is for indicating whether NNPF SEI messages are present in pair in the SPO SEI message, i.e., an NNPF characteristic SEI message is indicated like other non-NNPF SEI messages followed by indicating the corresponding NNPF activation SEI message. In some embodiments, SPO SEI message may be modified according to the following Table 7.

TABLE 7

| | Descriptor |
|---|---|
| sei_processing_order( payloadSize ) { | |
| po_num_sei_messages_minus2 | u(8) |
| for( i = 0; i < po_num_sei_messages_minus2 + 2; i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_6bits | u(6) |
| sei_message( ) | |
| sei_activation_present_flag[ i ] | u(1) |
| if(sei_activation_present_flag[ i ] ) { | |
| reserved_alignment_7bit | u(7) |
| sei_message( ) //The corresponding activation SEI | |
| message, if applicable. | |
| } | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; j++ ) | |
| po_prefix_byte[ i ][ j ] | b(8) |
| } | |
| sei_activation_present_flag[ i ] | u(1) |
| if(sei_activation_present_flag[ i ] ) { | |
| reserved_alignment_7bit | u(7) |
| sei_message( ) //The corresponding activation SEI | |
| message, if applicable. | |
| } | |
| } | |
| } | |
| } | |

b. SEI Processing Order Group (SPOG)

For each picture in the video, there can be multiple persisting or activated SEI messages belonging to one or more groups of SEI messages. Groups of SEI messages can be alternatives to each other, i.e., such that at most one group is chosen to be applied, or they can be complementary, i.e., such that more than one group is chosen and applied separately, with each group generating one output.

In some embodiments, two types of SEI messages are used for specifying processing order for groups of SEI messages: SEI processing order group characteristic (SPOGC) SEI messages and SEI processing order group activation (SPOGA) SEI messages. A SPOGC SEI message may identify one or more SEI messages as a SEI processing order group (SPOG) using a unique SPOG identifier and an initial processing order type. A SPOGA SEI message, when present, specifies the final processing order type for one or more SPOGs that were specified by the SPOGC SEI messages. The SPOGA SEI message is applied to one or more associated pictures and specifies the scope of persistence of the indicated one or more SPOGs. The SPOGC SEI messages (one or more) when present in the bitstream precede the SPOGA SEI message.

The SPOGC SEI message carries information indicating the preferred processing order type, as determined by the encoder (i.e., the content producer), for different types of SEI messages that may be present in a coded video sequence (CVS). Table 8 below shows the syntax of a SPOG characteristic (SPOGC) SEI message for some embodiments:

TABLE 8

| | Descriptor |
|---|---|
| sei_processing_order_group_characteristic( payloadSize ) { | |
| spogc_id | u(8) |
| spogc_purpose | u(8) |
| spogc_type | u(4) |
| spogc_num_sei_messages_minus1 | u(8) |
| for( i = 0; i < spogc_num_sei_messages_minus1 + | |
| 1; i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_2bits | u(2) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; j++ ) | |
| po_prefix_byte[ i ][ j ] | b(8) |
| } | |
| } | |
| sei_activation_present_flag[ i ] | u(1) |
| if(sei_activation_present_flag[ i ] ) { | |
| reserved_alignment_7bit | u(7) |
| sei_message( ) //The corresponding activation SEI | |
| message, if | |
| applicable. | |
| } | |
| } | |
| } | |

spogc_id contains an identifying number that may be used to identify an SPOG. The value of spogc_id shall be in the range of 0 to 255. The value of spogc_id shall be unique and different from other values of spogc_id in the bitstream.

spogc_purpose indicates the purpose of the SPOG and has the semantics of spogc_purpose. Definition of spogc_purpose and spoga_purpose is specified in Table 9 below:

TABLE 9

| Values of | |
|---|---|
| spogc_purpose and | |
| spoga_purpose | Description (to be defined) |
| 0 | Unspecified or specified by external means |
| 1 | (Purpose 1) |
| 2 | (Purpose 2) |
| 3 | (Purpose 3) |
| 4-255 | Reserved |

spogc_type indicates the processing order type for the SPOG. The semantics of spogc_type as specified in Table 10 below. The value of spogc_type shall be in the range of 0 to 7, inclusive, in bitstreams conforming to this edition of this document. Values of 4 to 7, inclusive, for spogc_type are reserved for future use may not be present in bitstreams conforming to this document. Decoders conforming to this document shall ignore SPOGC SEI messages with spogc_type in the range of 4 to 7, inclusive.

spogc_num_sei_messages_minus1 plus 1 indicates the number of SEI messages that have a processing order type spogc_type (specified in Table 10) indicated in SPOGC SEI message below.

TABLE 10

| Values of | |
|---|---|
| spogc_type | |
| and | |
| spoga_type | Description |
| 0 | Unspecified (e.g., it may be used for a single SEI |
| | message in an SPOGC SEI message with spogc_type or |
| | a single SPOG in an SPOGA SEI message with |
| | spoga_type.) |
| 1 | Cascade - The SEI messages in an SPOGC SEI message |
| | with spogc_type or the SPOGs in an SPOGA SEI message |
| | with spoga_type is applied in the sequential order |
| | with the index i, which means in a way that the |
| | indicated SEI messages or SPOGs are ordered with |
| | increasing values of the index i. |
| 2 | Alternate - The SEI messages in an SPOGC SEI message |
| | with spogc_type or the SPOGs in an SPOGA SEI message |
| | with spoga_type is applied alternatively (only one |
| | is chosen). |
| 3 | Parallel - The SEI messages in an SPOGC SEI message |
| | withs pogc_type or the SPOGs in an SPOGA SEI message |
| | with spoga_type is applied in parallel. |
| 4-7 | Reserved |

sei_activation_present_flag[i] equal to 1 indicates the activation SEI message following the i-th SEI message is present. sei_activation_present_flag[i] equal to 0 indicates the activation SEI message following the i-th SEI message is not present. The activation SEI message, when present, is applicable for the i-th SEI message as the activation for use.

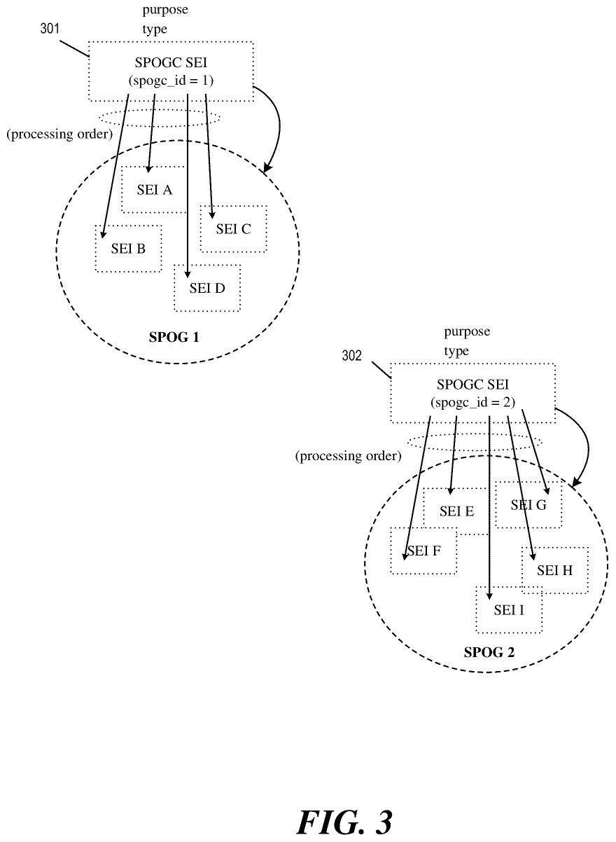

FIG. 3 conceptually illustrates SPOGC SEI messages for setting the characteristics of SPOGs. The figure illustrates two example SPOGC SEI messages 301 and 302 complying with syntax of Table 8. In the figure, the SPOGC SEI message 301 having spogc_id=1 defines a SPOG (SPOG1) that includes several SEI messages A, B, C, and D. The SPOGC SEI sets the processing order of the SEI messages in the SPOG, as well as the purpose and type parameters of the SPOG. The SPOGC SEI message 302 having spogc_id=2 defines a SPOG (SPOG2) that includes SEI messages E, F, G, H, and I. The SPOGC SEI sets the processing order of the SEI messages in the SPOG, as well as the purpose and type parameters of the SPOG.

The use of SPOGs for specific pictures is indicated with SPOG activation (SPOGA) SEI messages indicating the preferred final processing order types. SPOGA SEI messages identifies one or more SPOGs for specific pictures (individual SPOGs are identifiable by spogc_id). A SPOGA SEI message may indicate multiple SPOGs for a specific picture with a collective SPOG activation id. The SPOGA SEI message may also indicate the preferred processing order type for SPOGs identified by target values of SPOG id. Table 11 below shows syntax of a SPOGA SEI message for some embodiments:

TABLE 11

| | Descriptor |
|---|---|
| sei_processing_order_group_activation( payloadSize ) { | |
| spoga_activation_id | u(8) |
| spoga_cancel_flag | u(1) |
| if( !spoga_cancel_flag ) { | |
| spoga_persistence_flag | u(1) |
| spoga_purpose | u(8) |
| spoga_type | u(4) |
| spoga_num_spog_minus1 | u(8) |
| for( i = 0; i < spoga_num_pogc_minus1 + 1; i++ ) | |
| spoga_target_id[ i ] | u(8) |
| } | |
| } | |

The SPOGA SEI message activates or de-activates the use of the target SEI processing order groups (SPOGs), identified by spoga_target_id[i] for i=0 to spoga_num_pogc_minus1, inclusive, with the preferred processing order type, as determined by the encoder (i.e., the content producer), collectively identified by spoga_activation_id, for processing of a set of pictures.

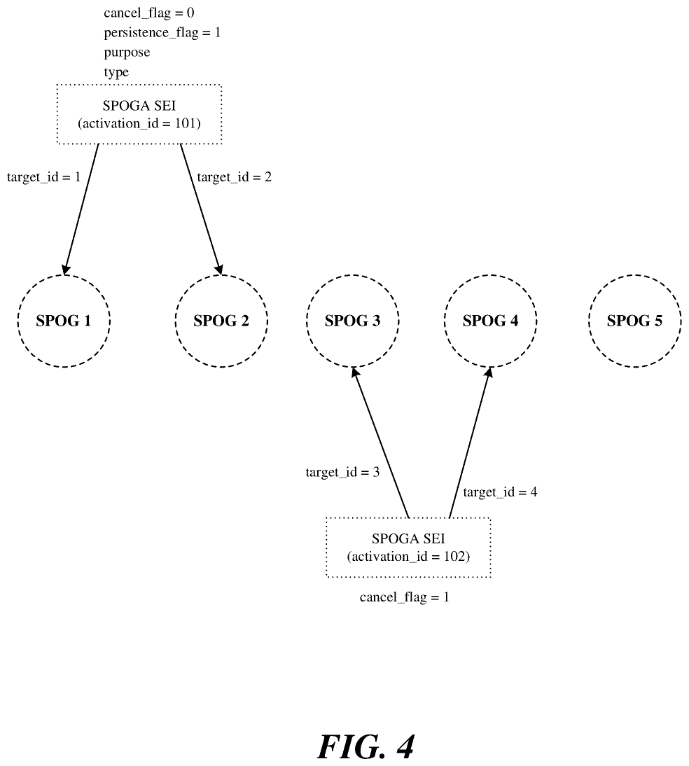

FIG. 4 illustrates SPOGA SEI messages that activates or deactivate one or more target SPOGs. The figure illustrates two example SPOGC SEI messages 401 and 402 complying with syntax of Table 11. In the figure, the SPOGA SEI message 401 having activation_id=101 activates two SPOGs (SPOG1 and SPOG2) with respective group identifiers (target_id=1 and target_id=2) by setting the persistence, purpose, and type parameters. The SPOGA SEI message 402 having activation_id=102 deactivates two SPOGs (SPOG3 and SPOG4) by setting the cancel parameter.

For a particular picture for which the SPOGs are activated, the target SPOGs are the SPOGs (each SPOG comprising the applied SEI messages) specified by the SPOG characteristic (SPOGC) SEI messages, identified by spoga_target_id[i], for i=0 to spoga_num_pogc_minu1+1, inclusive, that precedes the first VCL NAL unit of the current picture in decoding order and the SPOGs of the target SPOGs are defined by the SPOGC SEI messages that have spogc_id equal to any spoga_target_id[i] value of the target SPOGs and are present in the current picture unit or precede the current picture in decoding order.

spoga_activation_id contains an identifying number that may be used to identify an SPOGA. The value of spogc_activation_id shall be in the range of 0 to 255. The value of spoga_activation_id shall be unique and different from other values of spoga_activation_id in the bitstream.

spoga_cancel_flag equal to 1 indicates that the SEI message cancels the persistence of the target SPOG specified by any previous SPOGA SEI message with the same spoga_target_id as the current SEI message in output order that applies to the current layer. spoga_cancel_flag equal to 0 indicates that the target SPOG is activated for use.

spoga_persistence_flag specifies the persistence of the target SPOGs for the current layer. spoga_persistence_flag equal to 0 specifies that the target SPOGs applies to the current decoded picture only. spoga_persistence_flag equal to 1 specifies that the target SPOGs applies to the current decoded picture and persists for all subsequent pictures of the current layer in output order until one or more of the following conditions are true:
A new coded layer video sequence (CLVS) of the current layer begins.
The bitstream ends.
A picture in the current layer in an AU associated with a SPOGA SEI message with the same spoga_activation_id as the current SEI message that follows the current picture in output order.

spoga_purpose indicates the purpose of the SPOG and has the semantics of spoga_purpose as specified in Table 9.

spoga_type indicates the SEI processing order type for the SPOG and has the semantics of spoga_type as specified in Table 10. The value of spoga_type shall be in the range of 0 to 7, inclusive, in bitstreams conforming to this edition of this document. Values of 4 to 7, inclusive, for spoga_type are reserved for future use and shall not be present in bitstreams conforming to this edition of this document. Decoders conforming to this document shall ignore SPOGA SEI messages with spoga_type in the range of 4 to 7, inclusive.

spoga_num_spog_minus1 plus 1 indicates the number of SPOGs that have a processing order type spoga_type as specified in Table 10 indicated in the SPOGA SEI message.

spoga_target_id[i] indicates the i-th target SPOG, which is specified by an SPOGC SEI message that pertain to the current picture and have spogc_id equal to spoga_target_id[i]. The value of spoga_target_id[i] shall be in the range of 0 to 255.

c. Recursively Defined SPOG

In some embodiments, a SPOG can be defined recursively to include other SPOGs as well as individual SEI messages. In some embodiments, a SPOGC SEI message may operate on a combination of two or more individual SEI messages and/or SPOGs by treating the combination as a SPOG and assigning the combination a unique SPOG identifier and a processing order type. Table 12 below shows a SPOGC SEI message that defines a SPOG recursively (may include SPOGs and SEI messages).

TABLE 12

| | Descriptor |
|---|---|
| sei_processing_order_group_characteristic( payloadSize ) { | |
| spogc_id | u(8) |
| spogc_purpose | u(8) |
| spogc_type | u(4) |
| spogc_num_sei_messages_minus2 | u(8) |
| for( i = 0; i < spogc_num_sei_messages_minus2 + 2; | |
| i++) { | |
| spogc_member_id_present_flag[ i ] | u(1) |
| if( spogc_member_id_present_flag[ i ] ) | |
| spogc_member_id[ i ] | u(8) |
| else { | |
| po_sei_wrapping_flag[ i ] | u(1) |
| po_sei_importance_flag[ i ] | u(1) |
| if( po_sei_wrapping_flag[ i ] ) { | |
| reserved_alignment_2bits | u(2) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ i ]; j++ ) | |
| po_prefix_byte[ i ][ j ] | b(8) |
| } | |
| } | |
| sei_activation_present_flag[ i ] | u(1) |
| if(sei_activation_present_flag[ i ] ) { | |
| reserved_alignment_7bit | u(7) |
| sei_message( ) //The corresponding activation SEI | |
| message, if applicable. | |
| } | |
| } | |
| } | |
| } | |

The SPOGC SEI message carries information indicating the preferred processing order type, as determined by the encoder (i.e., the content producer), for a combination of different types of SEI messages and/or SPOGs. The recursive combination is identified by spogc_id in the SPOGC SEI message, which may be present in a CVS. The use of SPOG, identified by spogc_id, for specific pictures is indicated with SPOG activation (SPOGA) SEI messages with a target SPOG id.

spogc_num_sei_messages_minus2 plus 2 indicates the combined number of SEI messages and/or SPOGs that have a processing order type spogc_type (as specified in Table 10) indicated in the SPOGC SEI message.

In some embodiments, as shown in Table 12, identifiers of individual members of a SPOG that is itself a nested SPOG may be identified in the SPOGC SEI message using spogc_member_id.

spogc_member_id_present_flag[i] equal to 1 specifies that spogc_member_id[i] is present. spogc_member_id_present_flag[i] equal to 0 specifies spogc_member_id[i] is not present.

spogc_member_id[i] when present, indicates that the i-th SPOG indicated in this SPOGC SEI message has spogc_id equal to spogc_member_id[i]. Each SPOG with spogc_id equal to spogc_member_id[i] is defined by an SPOGC SEI message.

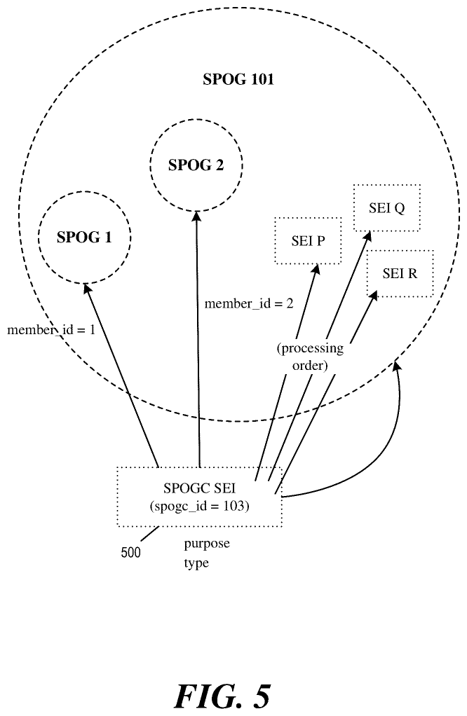

FIG. 5 conceptually illustrates a SPOGC SEI message for setting the characteristics a SPOG that includes both SPOGs and SEI messages. The figure illustrates a SPOGC SEI message 500 that sets the characteristics of a SPOG (SPOG101), including purpose and type. The SPOG101 recursively includes several SPOGs (SPOG1 and SPOG2) and several SEI messages, to which the SPOG101 assigns processing order.

One or more such SPOGC SEI messages may precede a corresponding SPOGA SEI message when present in the bitstream. The SPOGA SEI message, when present, signals a target SPOG (which may recursively include SEI messages and SPOGs) with a target SPOG identifier that is applied to the associated picture. The SPOGA SEI also specifies a scope of persistence for the targeted SPOG.

In some embodiments, instead of using a collective activation id to target several SPOGs, the SPOGA SEI message activates or de-activates one specific target SPOG, identified by spoga_target_id, for processing of a set of pictures. Table 13 below shows a SPOGA SEI message with SPOGA target identifier.

TABLE 13

| | Descriptor |
|---|---|
| sei_processing_order_group_activation( payloadSize ) { | |
| spoga_target_id | u(8) |
| spoga_cancel_flag | u(1) |
| if( !spoga_cancel_flag ) { | |
| spoga_persistence_flag | u(1) |
| } | |
| } | |

For a particular picture for which the SPOG is activated, the target SPOG is the SPOG specified by an earlier SPOGC SEI message, identified by spoga_target_id that precedes the first VCL NAL unit of the current picture in decoding order and the SPOG of the target SPOG is defined by the SPOGC SEI message that have spogc_id equal to spoga_target_id of the target SPOG and is present in the current picture unit or precede the current picture in decoding order.

spoga_target_id indicates the target SPOG, which is specified by an SPOGC SEI message that pertain to the current picture and have spogc_id equal to spoga_target_id. The value of spoga_target_id shall be in the range of 0 to 255.

spoga_cancel_flag equal to 1 indicates that the SEI message cancels the persistence of the target SPOG specified by any previous SPOGA SEI message with the same spoga_target_id as the current SEI message in output order that applies to the current layer. spoga_cancel_flag equal to 0 indicates that the target SPOG is activated for use.

spoga_persistence_flag specifies the persistence of the target SPOGs for the current layer. spoga_persistence_flag equal to 0 specifies that the target SPOGs applies to the current decoded picture only. spoga_persistence_flag equal to 1 specifies that the target SPOGs applies to the current decoded picture and persists for all subsequent pictures of the current layer in output order until one or more of the following conditions are true:
A new CLVS of the current layer begins.
The bitstream ends.
A picture in the current layer in an AU associated with a SPOGA SEI message with the same spoga_activation_id as the current SEI message that follows the current picture in output order.

In the example SPOGC SEI message of Table 12, identifiers of individual members of a SPOG (whether SEI messages or nested SPOGs) are indicated in the SPOGC SEI message by spogc_member_id. In some other embodiments, a SPOGC SEI message does not specify the identifiers of individual members. Table 14 below shows such a SPOGC SEI message:

TABLE 14

| | Descriptor |
|---|---|
| sei_processing_order_group_characteristic( payloadSize ) { | |
| spogc_id | u(8) |
| spogc_purpose | u(8) |
| spogc_type | u(4) |
| spogc_num_sei_messages_minus2 | u(8) |
| for( i = 0; i < spogc_num_sei_messages_minus2 + 2; | |
| i++) { | |
| po_sei_wrapping_flag[ i ] | u(1) |
| po_sei_importance_flag[ i ] | u(1) |
| if( po_sei_wrapping_flag[ i ] ) { | |
| reserved_alignment_2bits | u(2) |
| sei_message( ) | |
| } else { | |
| po_sei_prefix_flag[ i ] | u(1) |
| po_sei_payload_type[ i] | u(13) |
| if( po_sei_prefix_flag[ i ]) { | |
| po_num_prefix_bytes[ i ] | b(8) |
| for( j = 0; j < po_num_prefix_bytes[ i ]; j++) | |
| po_prefix_byte[ i ][ j ] | b(8) |
| } | |
| } | |
| sei_activation_present_flag[ i ] | u(1) |
| if(sei_activation_present_flag[ i ] ) { | |
| reserved_alignment_7bit | u(7) |
| sei_message( ) //The corresponding activation SEI | |
| message, if | |
| applicable. | |
| } | |
| } | |
| } | |

spogc_num_sei_messages_minus2 plus 2 indicates the number of SEI messages that have a processing order type spogc_type (as specified in Table 10) indicated in the SPOGC SEI message.

The SEI processing order group (SPOG) characteristic (SPOGC) SEI message carries information indicating the preferred processing order type, as determined by the encoder (i.e., the content producer), for different types of SEI messages that may be present in a CVS.

The use of combination of SPOGs, identified by spogc_id, and/or other SEI messages for specific pictures is indicated with SPOGA SEI messages. The SPOGA SEI message may target a specific SPOG using a target id as in the example of Table 13 above. The SPOGA SEI message may also target a set of SPOGs with a collective SPOG activation id, indicating the preferred processing order types, as determined by the encoder (i.e., the content producer). Each of the set of SPOGs identified by the collective SPOG activation id may be a combination of nested SPOGs and SEI messages. For a particular picture for which the SEI messages are activated, for which a SPOG may include nested SPOGs and SEI messages, a SPOGA SEI message that activates a collection of SPOGs is shown in Table 15.

TABLE 15

| | Descriptor |
|---|---|
| sei_processing_order_group_activation( payloadSize ) { | |
| spoga_activation_id | u(8) |
| spoga_cancel_flag | u(1) |
| if( !spoga_cancel_flag ) { | |
| spoga_persistence_flag | u(1) |
| spoga_purpose | u(8) |
| spoga_type | u(4) |
| spoga_num_sei_messages_minus1 | u(8) |
| for( i = 0; i < spoga_num_sei_messages_minus1 + 1; | |
| i++) { | |
| spoga_member_id_present_flag[ i ] | u(1) |
| if( spoga_member_id_present_flag[ i ] ) | |
| spoga_member_id[ i ] | u(8) |
| else { | |
| po_sei_wrapping_flag[ i ] | u(1) |
| po_sei_importance_flag[ i ] | u(1) |
| if( po_sei_wrapping_flag[ i ] ) { | |
| reserved_alignment_2bits | u(2) |
| sei_message( ) | |
| } else { | |
| po_sei_prefix_flag[ i ] | u(1) |
| po_sei_payload_type[ i ] | u(13) |
| if( po_sei_prefix_flag[ i ]) { | |
| po_num_prefix_bytes[ i ] | b(8) |
| for( j = 0; j < po_num_prefix_bytes[ | |
| i ]; j++ ) | |
| po_prefix_byte[ i ][ j ] | b(8) |
| } | |
| } | |
| sei_activation_present_flag[ i ] | u(1) |
| if(sei_activation_present_flag[ i ] ) { | |
| reserved_alignment_7bit | u(7) |
| sei_message( ) //The corresponding activation | |
| SEI message, if applicable. | |
| } | |
| } | |
| } | |
| } | |
| } | |

The SPOGA SEI message of Table 15 activates or de-activates the use of the combination of target SEI messages identified with the index i, and/or target SPOGs identified by spoga_target_id [i] or spoga_member_id [i], for i in the range of 0 to spoga_num_sei_messages_minus1, inclusive. The combination is collectively identified by spoga_activation_id for processing of a set of pictures with the preferred processing order type (as determined by the encoder or the content producer).

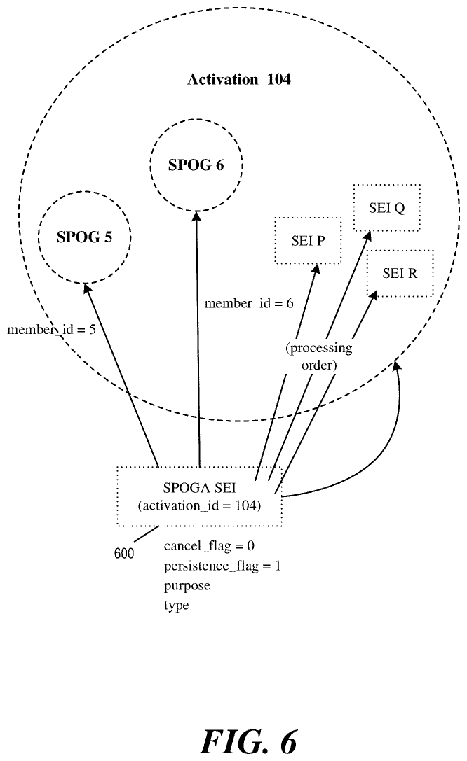

FIG. 6 conceptually illustrates a SPOGA SEI message that activates or deactivates a combination that includes both SPOGs and SEI messages. As illustrated, a SPOGA SEI message 600 collectively activates several SPOGs and SEI messages as a combination identified by an activation id (activation_id=104). The SPOGs of the combination are identified by their respective spoga_member_id, while the SEI messages (P, Q, and R) of the combination are assigned processing orders. The SPOGA SEI message 600 may de-activate the entire activation group by setting the cancel parameter, or setting the persistence, purpose, and type parameters of the group.

For a particular picture for which the SPOGs are activated, the target SPOGs are the SPOGs (comprising the applied SEI messages) specified by an earlier corresponding SPOGC SEI messages. The target SPOGs are identified by spoga_member_id[i], for i in the range of 0 to spoga_num_sei_messages_minus1, inclusive, that precedes the first VCL NAL unit of the current picture in decoding order. The target SPOGs are defined by the SPOGC SEI messages to have spogc_id equal to any spoga_member_id[i] value in the SPOGA SEI messages and are present in the current picture unit or precede the current picture in decoding order.

For a particular picture for which the SEI messages are activated, the target SEI messages are the SEI messages indicated in this SEI message with the index i, for i in the range of 0 to spoga_num_sei_messages_minus1, inclusive.

spoga_activation_id contains an identifying number that may be used to identify an SPOGA. The value of spogc_activation_id shall be in the range of 0 to 255. The value of spoga_activation_id shall be unique and different from other values of spoga_activation_id in the bitstream.

spoga_cancel_flag equal to 1 indicates that the SEI message cancels the persistence of the combination of target SEI messages and/or target SPOGs specified by any previous SPOGA SEI message with the same spoga_activation_id as the current SEI message in output order that applies to the current layer. spoga_cancel_flag equal to 0 indicates that the combination of target SEI messages and/or target SPOGs are activated for use and the information follows.

spoga_persistence_flag specifies the persistence of the combination of target SEI messages and/or target SPOGs for the current layer. spoga_persistence_flag equal to 0 specifies that the combination target SEI messages and/or target SPOGs applies to the current decoded picture only. spoga_persistence_flag equal to 1 specifies that the combination target SEI messages and/or target SPOGs applies to the current decoded picture and persists for all subsequent pictures of the current layer in output order until one or more of the following conditions are true:
A new CLVS of the current layer begins.
The bitstream ends.
A picture in the current layer in an AU associated with a SPOGA SEI message with the same spoga_activation_id as the current SEI message that follows the current picture in output order.

spogc_num_sei_messages_minus2 plus 2 indicates the combined number of SEI messages and/or SPOGs that have a processing order type spogc_type as specified in Table X2 indicated in the SPOGC SEI message.

spoga_member_id_present_flag[i] equal to 1 specifies that spoga_member_id[i] is present. spoga_member_id_present_flag[i] equal to 0 specifies spoga_member_id[i] is not present.

spoga_member_id[i] when present, indicates that the i-th SPOG indicated in this SPOGA SEI message has spogc_id equal to spoga_member_id[i]. Each SPOG with spogc_id equal to spoga_member_id[i] is defined by an SPOGC SEI message.

### III. Example Video Encoder

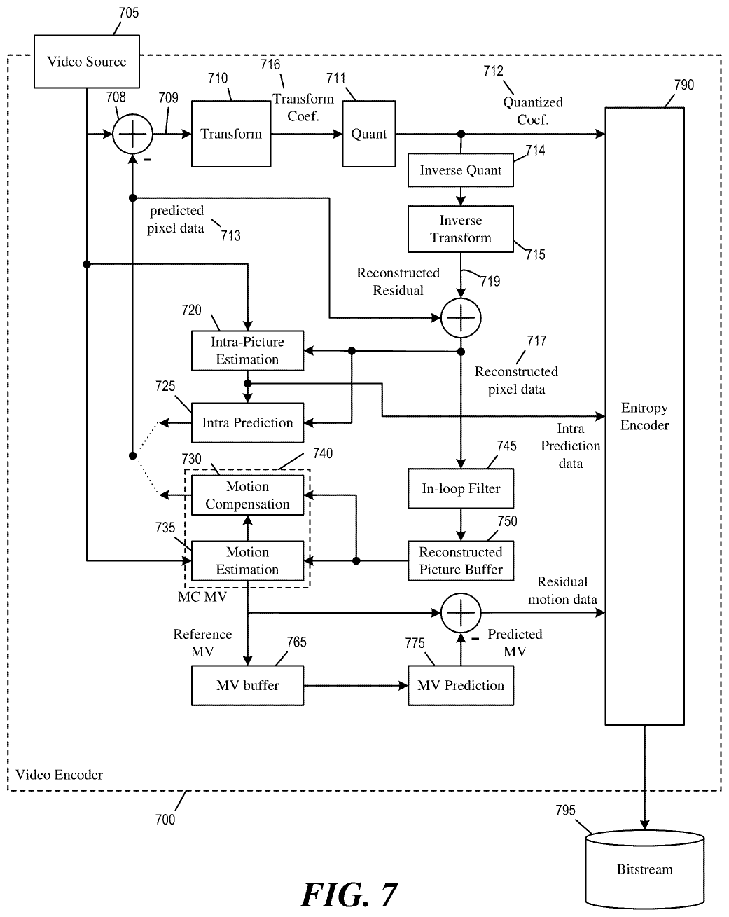

FIG. 7 illustrates an example video encoder 700 that may be part of a video streaming server. As illustrated, the video encoder 700 receives input video signal from a video source 705 and encodes the signal into bitstream 795. The video encoder 700 has several components or modules for encoding the signal from the video source 705, at least including some components selected from a transform module 710, a quantization module 711, an inverse quantization module 714, an inverse transform module 715, an intra-picture estimation module 720, an intra-prediction module 725, a motion compensation module 730, a motion estimation module 735, an in-loop filter 745, a reconstructed picture buffer 750, a MV buffer 765, and a MV prediction module 775, and an entropy encoder 790. The motion compensation module 730 and the motion estimation module 735 are part of an inter-prediction module 740.

In some embodiments, the modules 710-790 are modules of software instructions being executed by one or more processing units (e.g., a processor) of a computing device or electronic apparatus. In some embodiments, the modules 710-790 are modules of hardware circuits implemented by one or more integrated circuits (ICs) of an electronic apparatus. Though the modules 710-790 are illustrated as being separate modules, some of the modules can be combined into a single module.

The video source 705 provides a raw video signal that presents pixel data of each video frame without compression. A subtractor 708 computes the difference between the raw video pixel data of the video source 705 and the predicted pixel data 713 from the motion compensation module 730 or intra-prediction module 725 as prediction residual 709. The transform module 710 converts the difference (or the residual pixel data or residual signal 708) into transform coefficients (e.g., by performing Discrete Cosine Transform, or DCT). The quantization module 711 quantizes the transform coefficients into quantized data (or quantized coefficients) 712, which is encoded into the bitstream 795 by the entropy encoder 790.

The inverse quantization module 714 de-quantizes the quantized data (or quantized coefficients) 712 to obtain transform coefficients, and the inverse transform module 715 performs inverse transform on the transform coefficients to produce reconstructed residual 719. The reconstructed residual 719 is added with the predicted pixel data 713 to produce reconstructed pixel data 717. In some embodiments, the reconstructed pixel data 717 is temporarily stored in a line buffer (not illustrated) for intra-picture prediction and spatial MV prediction. The reconstructed pixels are filtered by the in-loop filter 745 and stored in the reconstructed picture buffer 750. In some embodiments, the reconstructed picture buffer 750 is a storage external to the video encoder 700. In some embodiments, the reconstructed picture buffer 750 is a storage internal to the video encoder 700.

The intra-picture estimation module 720 performs intra-prediction based on the reconstructed pixel data 717 to produce intra prediction data. The intra-prediction data is provided to the entropy encoder 790 to be encoded into bitstream 795. The intra-prediction data is also used by the intra-prediction module 725 to produce the predicted pixel data 713.

The motion estimation module 735 performs inter-prediction by producing MVs to reference pixel data of previously decoded frames stored in the reconstructed picture buffer 750. These MVs are provided to the motion compensation module 730 to produce predicted pixel data.

Instead of encoding the complete actual MVs in the bitstream, the video encoder 700 uses MV prediction to generate predicted MVs, and the difference between the MVs used for motion compensation and the predicted MVs is encoded as residual motion data and stored in the bitstream 795.

The MV prediction module 775 generates the predicted MVs based on reference MVs that were generated for encoding previously video frames, i.e., the motion compensation MVs that were used to perform motion compensation. The MV prediction module 775 retrieves reference MVs from previous video frames from the MV buffer 765. The video encoder 700 stores the MVs generated for the current video frame in the MV buffer 765 as reference MVs for generating predicted MVs.

The MV prediction module 775 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 795 by the entropy encoder 790.

The entropy encoder 790 encodes various parameters and data into the bitstream 795 by using entropy-coding techniques such as context-adaptive binary arithmetic coding (CABAC) or Huffman encoding. The entropy encoder 790 encodes various header elements, flags, along with the quantized transform coefficients 712, and the residual motion data as syntax elements into the bitstream 795. The bitstream 795 is in turn stored in a storage device or transmitted to a decoder over a communications medium such as a network.

The in-loop filter 745 performs filtering or smoothing operations on the reconstructed pixel data 717 to reduce the artifacts of coding, particularly at boundaries of pixel blocks. In some embodiments, the filtering or smoothing operations performed by the in-loop filter 745 include deblock filter (DBF), sample adaptive offset (SAO), and/or adaptive loop filter (ALF). In some embodiments, luma mapping chroma scaling (LMCS) is performed before the loop filters.

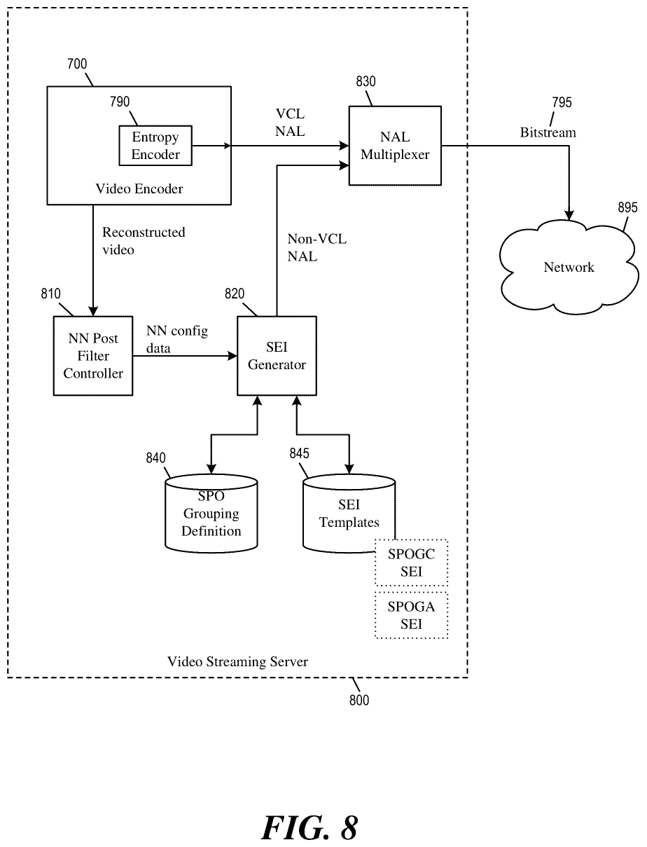

FIG. 8 illustrates a video streaming server device 800 that implements grouping of SEI messages. The video streaming server 800 includes the video encoder 700, a NN post filter controller 810, a SEI generator 820, and a NAL multiplexer 830. The NAL multiplexer 830 multiplexes between VCL NAL units generated by the video encoder 700 (at the entropy encoder 790) and non-VCL NAL units generated by the SEI generator 820 to produce the bitstream 795, which is provided to the network 895 to reach video streaming clients.

The NN post filter controller 810 receives information related to encoded video from the video encoder 700, which may include the reconstructed pixel data 717 or the content of the reconstructed picture buffer 750. The NN post filter controller 810 may also receive other information regarding the encoded video or specifically the current picture, such as the size of video, type of video frame, the prediction mode or coding tools used encode the current picture, etc. The NN post filter controller 810 uses the information provided by the video encoder 700 to calculate NN configuration data for configuring one or more NN post filters at the decoder side or the video streaming clients. The generated NN configuration data is provided to the SEI generator 820 to be delivered to the video streaming clients as SEI messages.

The SEI generator 820 generates SEI messages as non-VCL NAL units to be injected into the bitstream 795. The SEI generator generates various SEI messages, including SPO SEI messages for setting the processing orders of SEI messages in SEI processing order groups (SPOGs). Each SPOG is identified by a group identifier. The generated SEI messages may use the group identifier of a SPOG to set parameters for the SPOG. In Sections II.b, II.c, II.d, the group identifier is set by spogc_id in SPOGC SEI messages or by spoga_target_id or member_id in SPOGA SEI messages. The SEI generator 820 may reference a storage for SPO group definitions 840 and SEI templates 845 when generating SEI messages related to SPOGs.

Each SPOG may be related to a corresponding video picture so the parameters assigned to a SPOG using the group identifier may be applicable to only that specific picture or a particular set of pictures. For example, SEI messages in a SPOG related to a particular picture may be active for only that particular picture, and the SEI messages of the SPOG may carry NN configuration data that is valid for only that particular picture.

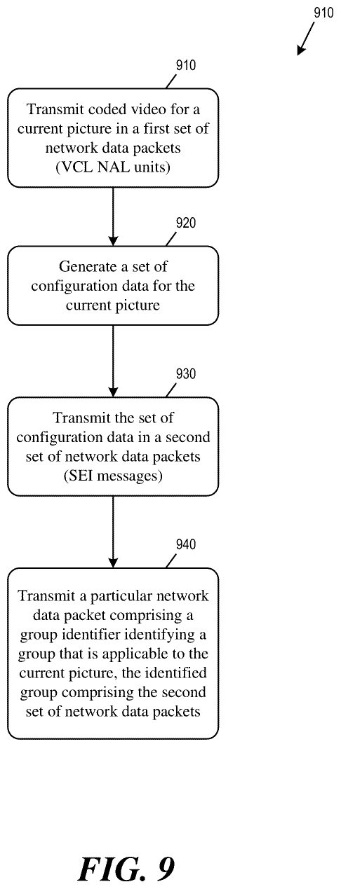

FIG. 9 conceptually illustrates a process 900 for using grouping of SEI messages by a video streaming server. In some embodiments, one or more processing units (e.g., a processor) of a computing device implementing the video streaming server 800 performs the process 900 by executing instructions stored in a computer readable medium. In some embodiments, an electronic apparatus implementing the video streaming server 800 performs the process 900.

The server transmits (at block 910) coded video for a current picture in a first set of network data packets (which may be VCL NAL units). The server generates (at block 920) a set of configuration data for the current picture. The server transmits (at block 930) the set of configuration data in a second set of network data packets (which may be non-VCL NAL units or SEI messages).

The server transmits (at block 940) a particular network data packet comprising a group identifier identifying a group that is applicable to the current picture. The identified group includes the second set of network data packets. The particular network data packet (e.g., SPO SEI message, SPOGA SEI message, SPOGC SEI message) may assign processing order to the network data packets in the second set of network data packets. The particular network data packet may be a SPOGC SEI message that associates persistence, purpose, grouping type, or other processing characteristics with the group identifier. The particular network data packet may be a SPOGA SEI message that activates or de-activates a processing function that uses the configuration data in the second set of network data packets. The activated/deactivated function may be a neural network post filter to be applied to the current picture and the generated configuration data is for configuring the neural network post filter. The group may be one of a plurality of groups that are associated with the current picture, the plurality of groups comprising multiple sets of network data packets for supporting respective multiple processing functions, which may be multiple neural network post filters to be applied to the current picture.

In some embodiments, the group identifier is a first group identifier for a first group comprising one or more network data packets and at least a second (nested) group associated with a second group identifier, with the second group including one or more network data packets.

### IV. Example Video Decoder

In some embodiments, an encoder may signal (or generate) one or more syntax element in a bitstream, such that a decoder may parse said one or more syntax element from the bitstream.

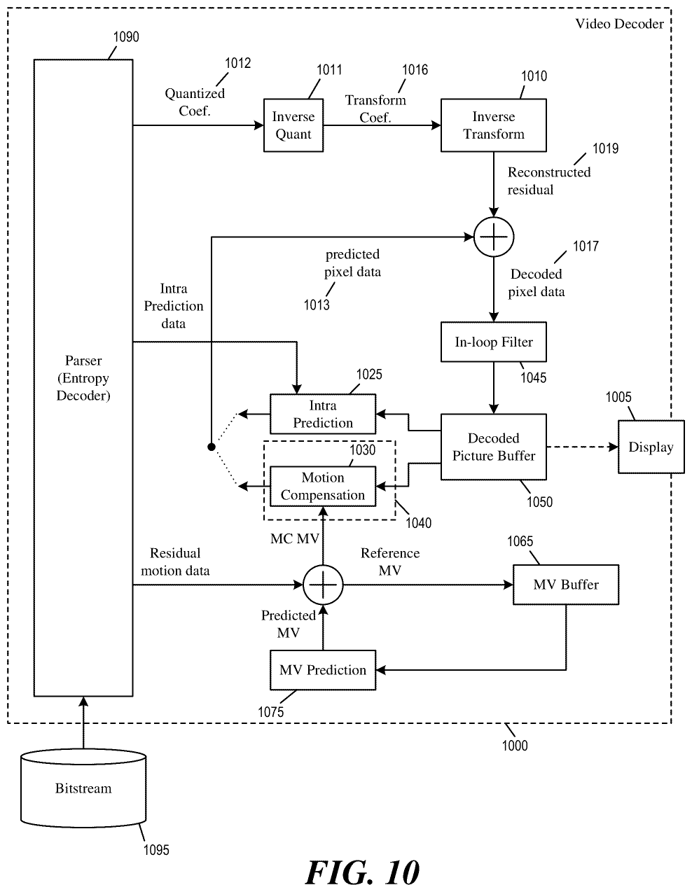

FIG. 10 illustrates an example video decoder 1000 that may be part of a video streaming client. As illustrated, the video decoder 1000 is an image-decoding or video-decoding circuit that receives a bitstream 1095 and decodes the content of the bitstream into pixel data of video frames for display. The video decoder 1000 has several components or modules for decoding the bitstream 1095, including some components selected from an inverse quantization module 1011, an inverse transform module 1010, an intra-prediction module 1025, a motion compensation module 1030, an in-loop filter 1045, a decoded picture buffer 1050, a MV buffer 1065, a MV prediction module 1075, and a parser 1090. The motion compensation module 1030 is part of an inter-prediction module 1040.

In some embodiments, the modules 1010-1090 are modules of software instructions being executed by one or more processing units (e.g., a processor) of a computing device. In some embodiments, the modules 1010-1090 are modules of hardware circuits implemented by one or more ICs of an electronic apparatus. Though the modules 1010-1090 are illustrated as being separate modules, some of the modules can be combined into a single module.

The parser 1090 (or entropy decoder) receives the bitstream 1095 and performs initial parsing according to the syntax defined by a video-coding or image-coding standard. The parsed syntax element includes various header elements, flags, as well as quantized data (or quantized coefficients) 1012. The parser 1090 parses out the various syntax elements by using entropy-coding techniques such as context-adaptive binary arithmetic coding (CABAC) or Huffman encoding.

The inverse quantization module 1011 de-quantizes the quantized data (or quantized coefficients) 1012 to obtain transform coefficients, and the inverse transform module 1010 performs inverse transform on the transform coefficients 1016 to produce reconstructed residual signal 1019. The reconstructed residual signal 1019 is added with predicted pixel data 1013 from the intra-prediction module 1025 or the motion compensation module 1030 to produce decoded pixel data 1017. The decoded pixels data are filtered by the in-loop filter 1045 and stored in the decoded picture buffer 1050. In some embodiments, the decoded picture buffer 1050 is a storage external to the video decoder 1000. In some embodiments, the decoded picture buffer 1050 is a storage internal to the video decoder 1000.

The intra-prediction module 1025 receives intra-prediction data from bitstream 1095 and according to which, produces the predicted pixel data 1013 from the decoded pixel data 1017 stored in the decoded picture buffer 1050. In some embodiments, the decoded pixel data 1017 is also stored in a line buffer (not illustrated) for intra-picture prediction and spatial MV prediction.

In some embodiments, the content of the decoded picture buffer 1050 is used for display. A display device 1005 either retrieves the content of the decoded picture buffer 1050 for display directly or retrieves the content of the decoded picture buffer to a display buffer. In some embodiments, the display device receives pixel values from the decoded picture buffer 1050 through a pixel transport.

The motion compensation module 1030 produces predicted pixel data 1013 from the decoded pixel data 1017 stored in the decoded picture buffer 1050 according to motion compensation MVs (MC MVs). These motion compensation MVs are decoded by adding the residual motion data received from the bitstream 1095 with predicted MVs received from the MV prediction module 1075.

The MV prediction module 1075 generates the predicted MVs based on reference MVs that were generated for decoding previous video frames, e.g., the motion compensation MVs that were used to perform motion compensation. The MV prediction module 1075 retrieves the reference MVs of previous video frames from the MV buffer 1065. The video decoder 1000 stores the motion compensation MVs generated for decoding the current video frame in the MV buffer 1065 as reference MVs for producing predicted MVs.

The in-loop filter 1045 performs filtering or smoothing operations on the decoded pixel data 1017 to reduce the artifacts of coding, particularly at boundaries of pixel blocks. In some embodiments, the filtering or smoothing operations performed by the in-loop filter 1045 include deblock filter (DBF), sample adaptive offset (SAO), and/or adaptive loop filter (ALF). In some embodiments, luma mapping chroma scaling (LMCS) is performed before the loop filters.

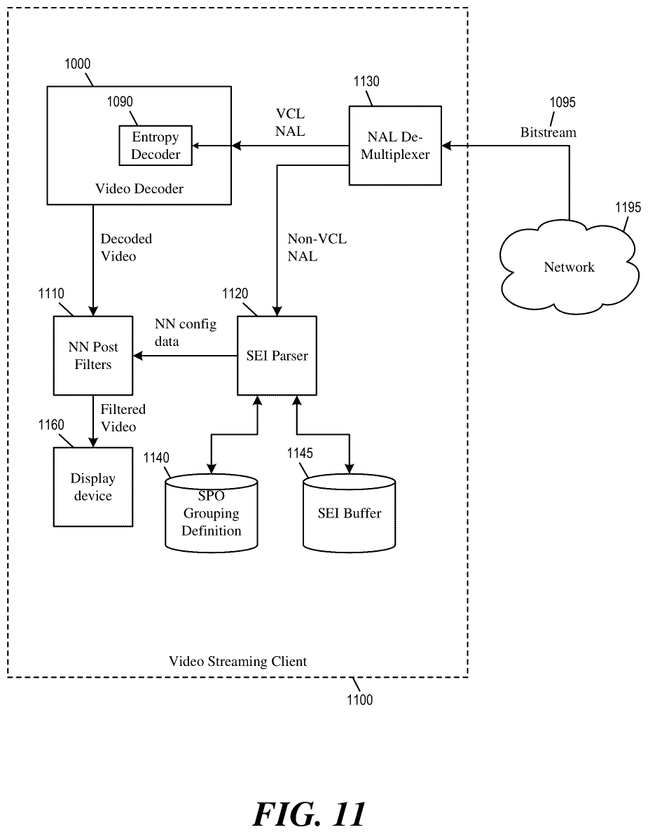

FIG. 11 illustrates a video streaming client device 1100 that implements grouping of SEI messages. The video streaming server 1100 includes the video decoder 1000, NN post filters 1110, a SEI parser 1120, and a NAL de-multiplexer 1130. The NAL de-multiplexer 1130 receives the bitstream 1095 from the network 1195 (from a video streaming server), parses and de-multiplexes the bitstream 1095 into VCL NAL units for the video decoder 1000 (to the entropy decoder 1090) and non-VCL NAL units for the SEI parser 1120.

The NN post filters 1110 applies post filtering to decoded video content received from the video decoder 1000, which may be the decoded pixel data 1017 or the content of the decoded picture buffer 1050. The NN post filters 1110 are configured by NN configuration data provided by SEI parser 1120, which parses the SEI messages from the video streaming server. The filtered video is then provided to a display device 1160 to be displayed, or outputted for another purpose.

The SEI parser 1120 receives SEI messages as non-VCL NAL units de-multiplexed from the bitstream 1095. The SEI parser 1120 may receive various SEI messages, including SPO SEI messages for setting the processing orders of SEI messages in SEI processing order groups (SPOGs). Each SPOG is identified by a group identifier. The generated SEI messages may use the group identifier of a SPOG to set parameters for the SPOG. In Sections II.b, II.c, II.d, the group identifier is set by spogc_id in SPOGC SEI messages or by spoga_target_id or member_id in SPOGA SEI messages. The SEI parser 1120 may reference a storage for SPO group definitions 840 and SEI buffer 845 when receiving SEI messages to construct the NN configuration data for the NN post filters 1110.

Each SPOG may be related to a corresponding video picture so the parameters assigned to a SPOG using the group identifier may be applicable to only that specific picture or a particular set of pictures. For example, SEI messages in a SPOG related to a particular picture may be active for only that particular picture, and the SEI messages of the SPOG may carry NN configuration data that is valid for only that particular picture.

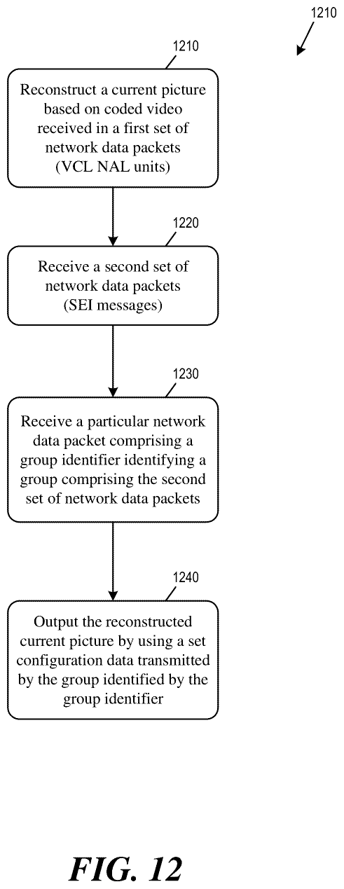

FIG. 12 conceptually illustrates a process 1200 for using grouping of SEI messages by a video streaming client. In some embodiments, one or more processing units (e.g., a processor) of a computing device implementing the decoder 1000 performs the process 1200 by executing instructions stored in a computer readable medium. In some embodiments, an electronic apparatus implementing the decoder 1000 performs the process 1200.

The client reconstructs (at block 1210) a current picture based on coded video received in a first set of network data packets (which may be VCL NAL units). The client receives (at block 1220) a second set of network data packets (which may be non-VCL NAL units or SEI messages.)

The client receives (at block 1230) a particular network data packet comprising a group identifier identifying a group. The group comprises the second set of network data packets. The identified group includes the second set of network data packets. The particular network data packet (e.g., SPO SEI message, SPOGA SEI message, SPOGC SEI message) may assign processing order to the network data packets in the second set of network data packets. The particular network data packet may be a SPOGC SEI message that associates persistence, purpose, grouping type, or other characteristics with the group identifier. The particular network data packet may be a SPOGA SEI message that activates or de-activates a processing function that uses the configuration data in the second set of network data packets. The activated/deactivated function may be a neural network post filter to be applied to the current picture and the generated configuration data is for configuring the neural network post filter. The group may be one of a plurality of groups that are associated with the current picture, the plurality of groups comprising multiple sets of network data packets for supporting respective multiple processing functions, which may be multiple neural network post filters to be applied to the current picture.

In some embodiments, the group identifier is a first group identifier for a first group comprising one or more network data packets and at least a second (nested) group associated with a second group identifier, with the second group including one or more network data packets.

The client outputs (at block 1240) (e.g., displays) the reconstructed current picture by using a set configuration data transmitted by network data packets in the group identified by the group identifier.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

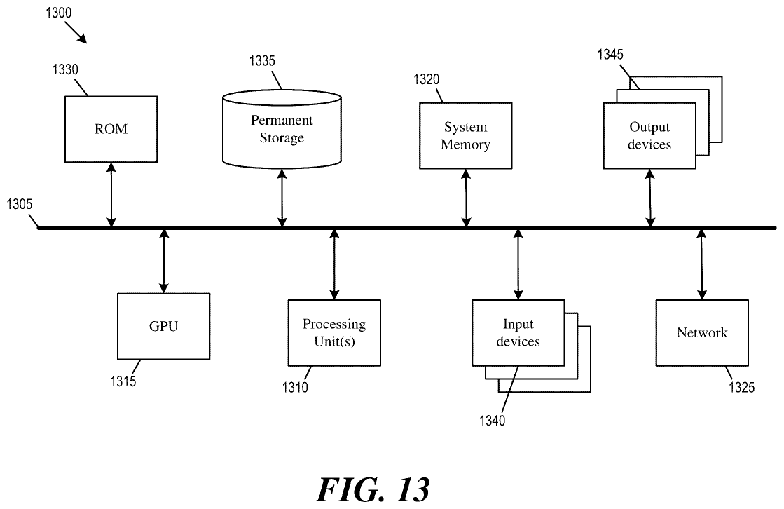

FIG. 13 conceptually illustrates an electronic system 1300 with which some embodiments of the present disclosure are implemented. The electronic system 1300 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1300 includes a bus 1305, processing unit(s) 1310, a graphics-processing unit (GPU) 1315, a system memory 1320, a network 1325, a read-only memory 1330, a permanent storage device 1335, input devices 1340, and output devices 1345.

The bus 1305 collectively represents all system, peripheral, and chipset buses that communicatively connect the numerous internal devices of the electronic system 1300. For instance, the bus 1305 communicatively connects the processing unit(s) 1310 with the GPU 1315, the read-only memory 1330, the system memory 1320, and the permanent storage device 1335.

From these various memory units, the processing unit(s) 1310 retrieves instructions to execute and data to process in order to execute the processes of the present disclosure. The processing unit(s) may be a single processor or a multi-core processor in different embodiments. Some instructions are passed to and executed by the GPU 1315. The GPU 1315 can offload various computations or complement the image processing provided by the processing unit(s) 1310.

The read-only-memory (ROM) 1330 stores static data and instructions that are used by the processing unit(s) 1310 and other modules of the electronic system. The permanent storage device 1335, on the other hand, is a read-and-write memory device. This device is a non-volatile memory unit that stores instructions and data even when the electronic system 1300 is off. Some embodiments of the present disclosure use a mass-storage device (such as a magnetic or optical disk and its corresponding disk drive) as the permanent storage device 1335.

Other embodiments use a removable storage device (such as a floppy disk, flash memory device, etc., and its corresponding disk drive) as the permanent storage device. Like the permanent storage device 1335, the system memory 1320 is a read-and-write memory device. However, unlike storage device 1335, the system memory 1320 is a volatile read-and-write memory, such a random access memory. The system memory 1320 stores some of the instructions and data that the processor uses at runtime. In some embodiments, processes in accordance with the present disclosure are stored in the system memory 1320, the permanent storage device 1335, and/or the read-only memory 1330. For example, the various memory units include instructions for processing multimedia clips in accordance with some embodiments. From these various memory units, the processing unit(s) 1310 retrieves instructions to execute and data to process in order to execute the processes of some embodiments.

The bus 1305 also connects to the input and output devices 1340 and 1345. The input devices 1340 enable the user to communicate information and select commands to the electronic system. The input devices 1340 include alphanumeric keyboards and pointing devices (also called “cursor control devices”), cameras (e.g., webcams), microphones or similar devices for receiving voice commands, etc. The output devices 1345 display images generated by the electronic system or otherwise output data. The output devices 1345 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 13, bus 1305 also couples electronic system 1300 to a network 1325 through a network adapter (not shown). In this manner, the computer can be a part of a network of computers (such as a local area network (“LAN”), a wide area network (“WAN”), or an Intranet, or a network of networks, such as the Internet. Any or all components of electronic system 1300 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 9 and FIG. 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video streaming method comprising:
reconstructing a current picture based on coded video received in a first set of network data packets;
receiving a second set of network data packets;
receiving a particular network data packet comprising a group identifier identifying a group comprising the second set of network data packets; and
processing and outputting the reconstructed current picture by using a set configuration data transmitted by the group identified by the group identifier.

2. The video streaming method of claim 1, wherein the particular network data packet assigns processing order to the network data packets in the second set of network data packets.

3. The video streaming method of claim 1, wherein the particular network data packet associates a processing characteristic with the group identifier.

4. The video streaming method of claim 1, wherein the particular network data packet associates a processing persistence and a processing purpose with the group identifier.

5. The video streaming method of claim 1, wherein the particular network data packet associates a processing grouping type with the group identifier.

6. The video streaming method of claim 1, wherein the particular network data packet activates or de-activates a processing function that uses the configuration data in the second set of network data packets.

7. The video streaming method of claim 6, wherein the processing function is a neural network post filter to be applied to the current picture and the generated configuration data is for configuring the neural network post filter.

8. The video streaming method of claim 1, wherein the group identifier is a first group identifier for a first group comprising one or more network data packets and at least a second group associated with a second group identifier, wherein the second group comprises one or more network data packets.

9. The video streaming method of claim 1, wherein the group is one of a plurality of groups that are associated with the current picture, the plurality of groups comprising multiple sets of network data packets for supporting respective multiple processing functions.

10. The video streaming method of claim 9, wherein the multiple processing functions comprise multiple neural network post filters to be applied to the current picture.

11. The video streaming method of claim 1, wherein each network data packet in the first set of data packets is a video coding layer (VCL) network abstraction layer (NAL) unit, and each network data packet in the second set of data packets is a supplemental enhancement information (SEI) message.

12. A video streaming method comprising:
transmitting coded video for a current picture in a first set of network data packets;
generating a set of configuration data for the current picture;
transmitting the set of configuration data in a second set of network data packets; and
transmitting a particular network data packet comprising a group identifier identifying a group that is applicable to the current picture, the identified group comprising the second set of network data packets.

13. An electronic apparatus comprising:
a video streaming client circuit configured to perform operations comprising:
reconstructing a current picture based on coded video received in a first set of network data packets;
receiving a second set of network data packets;
receiving a particular network data packet comprising a group identifier identifying a group comprising the second set of network data packets; and
processing and outputting the reconstructed current picture by using a set configuration data transmitted by the group identified by the group identifier.

14. An electronic apparatus comprising:
a video streaming client server configured to perform operations comprising:
transmitting coded video for a current picture in a first set of network data packets;
generating a set of configuration data for the current picture;
transmitting the set of configuration data in a second set of network data packets; and
transmitting a particular network data packet comprising a group identifier identifying a group that is applicable to the current picture, the identified group comprising the second set of network data packets.
